(19) United States
(12) Patent Application Publication
(10) Pub. No.: US 2018/0340507 A1
(43) Pub. Date: Nov. 29, 2018

(54) METHOD AND APPARATUS FOR CONTROLLING OPERATION OF AN INTERNAL COMBUSTION ENGINE

(71) Applicant: GM GLOBAL TECHNOLOGY OPERATIONS LLC, Detroit, MI (US)

(72) Inventors: Cherian A. Idicheria, Novi, MI (US); Hanho Yun, Warren, MI (US); Paul M. Najt, Bloomfield Hills, MI (US)

(73) Assignee: GM Global Technology Operations LLC, Detroit, MI (US)

(21) Appl. No.: 15/771,486

(22) PCT Filed: Dec. 3, 2015
(86) PCT No.: PCT/US15/63683

§ 371 Date: Apr. 27, 2018

(51) Int. Cl. F02P 23/04; F02F 1/24

(52) U.S. Cl. CPC F02P 23/04; F02F 1/24

(57) ABSTRACT

An internal combustion engine includes a combustion chamber defined by a cylinder bore in a cylinder block, a cylinder head and a piston. A groundless barrier discharge plasma igniter including an electrode is embedded in a casing fabricated from a dielectric material and is disposed in a mounting boss. The groundless barrier discharge plasma igniter has a tip portion that protrudes through an opening in the cylinder head into the combustion chamber. A controller having an electrical ground connection to the cylinder head is configured to apply a high frequency electrical pulse to the groundless barrier discharge plasma igniter. An electrical ground path is formed between the mounting boss and the cylinder head. A plurality of plasma discharge streamers is generated on the casing between the tip portion and the mounting boss when the controller applies the high frequency electrical pulse to the groundless barrier discharge plasma igniter.

### TECHNICAL FIELD

This disclosure relates to an internal combustion engine configured with a direct injection fuel system and a plasma igniter, and control thereof

### BACKGROUND

Known spark-ignition (SI) engines introduce an air/fuel mixture into each cylinder that is compressed during a compression stroke and ignited by a spark plug. Known compression-ignition (CI) engines inject pressurized fuel into a combustion chamber near top dead center (TDC) of the compression stroke that ignites upon injection. Combustion for both SI engines and CI engines involves premixed or diffusion flames controlled by fluid mechanics.

SI engines may operate in different combustion modes, including, by way of non-limiting examples, a homogeneous SI combustion mode and a stratified-charge SI combustion mode. SI engines may be configured to operate in a homogeneous-charge compression-ignition (HCCI) combustion mode, also referred to as controlled auto-ignition combustion, under predetermined speed/load operating conditions. HCCI combustion is a distributed, flameless, kinetically-controlled auto-ignition combustion process with the engine operating at a dilute air/fuel mixture, i.e., lean of a stoichiometric air/fuel point, with relatively low peak combustion temperatures, resulting in low NOx emissions. An engine operating in the HCCI combustion mode forms a cylinder charge that is preferably homogeneous in composition, temperature, and residual exhaust gases at intake valve closing time. The homogeneous air/fuel mixture minimizes occurrences of rich in-cylinder combustion zones that form smoke and particulate emissions.

Engine airflow may be controlled by selectively adjusting position of the throttle valve and adjusting openings and/or closings of intake valves and exhaust valves. On engine systems so equipped, the openings and/or closings of the intake valves and exhaust valves may be adjusted using a variable valve actuation system that may include variable cam phasing and a selectable multi-step valve lift, e.g., multiple-step cam lobes that provide two or more valve lift positions. In contrast to the throttle position change, the change in valve position of the multi-step valve lift mechanism may be a discrete step change.

### SUMMARY

An internal combustion engine includes a combustion chamber defined by a cylinder bore in a cylinder block, a cylinder head and a piston. A groundless barrier discharge plasma igniter including an electrode is embedded in a casing fabricated from a dielectric material and is disposed in a mounting boss. The groundless barrier discharge plasma igniter has a tip portion that protrudes through an opening in the cylinder head into the combustion chamber. A controller having an electrical ground connection to the cylinder head is configured to apply a high frequency electrical pulse to the groundless barrier discharge plasma igniter. An electrical ground path is formed between the mounting boss and the cylinder head. A plasma discharge streamer is generated on the casing between the tip portion and the mounting boss when the controller applies the high frequency electrical pulse to the groundless barrier discharge plasma igniter.

The above features and advantages, and other features and advantages, of the present teachings are readily apparent from the following detailed description of some of the best modes and other embodiments for carrying out the present teachings, as defined in the appended claims, when taken in connection with the accompanying drawings.

### BRIEF DESCRIPTION OF THE DRAWINGS

One or more embodiments will now be described, by way of example, with reference to the accompanying drawings, in which:

FIGS. 1-4 schematically illustrate cross-sectional views of embodiments of a single cylinder for an internal combustion engine including an in-cylinder groundless dielectric barrier-discharge plasma igniter of a plasma ignition system, in accordance with the disclosure;

FIG. 5 schematically illustrates a cross-sectional side view of an in-cylinder groundless dielectric barrier-discharge igniter mounted in a pass-through aperture of a cylinder head of an internal combustion engine, in accordance with the disclosure; and

FIG. 6 schematically illustrates an isometric view of an in-cylinder groundless dielectric barrier-discharge plasma igniter and depicting a plurality of streamers generated by a single plasma discharge event, in accordance with the disclosure.

### DETAILED DESCRIPTION

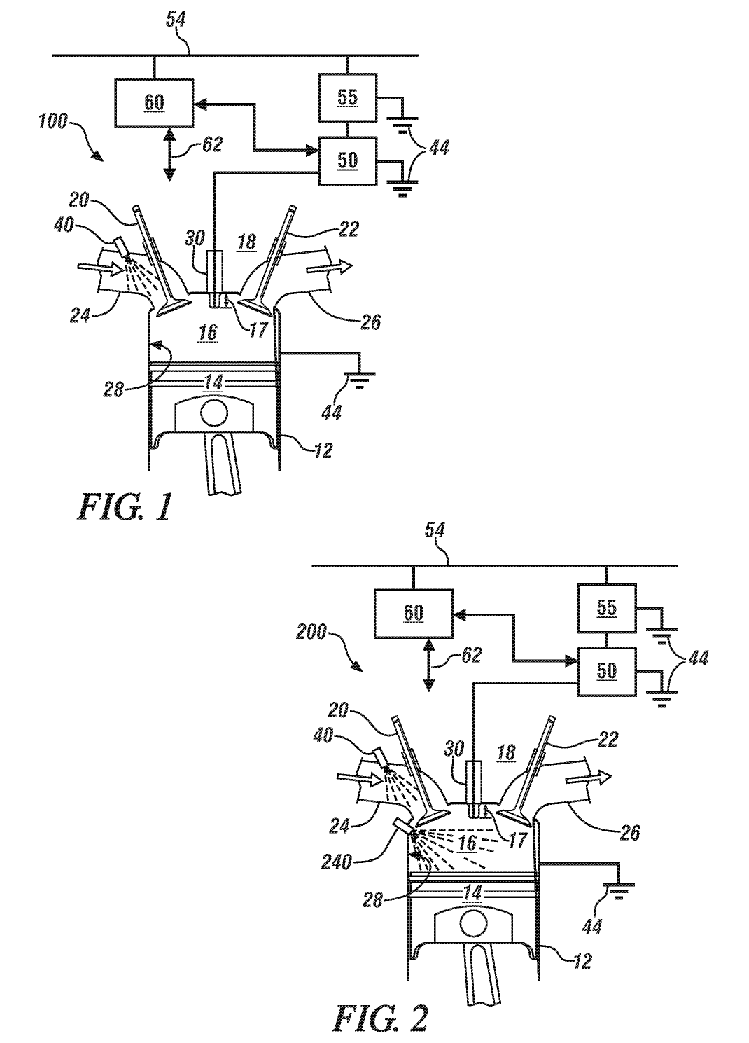

Referring now to the drawings, wherein the depictions are for the purpose of illustrating certain exemplary embodiments only and not for the purpose of limiting the same, FIG. 1 schematically illustrates a cross-sectional view of a single cylinder for a multi-cylinder internal combustion engine (engine) 100, including an engine block 12 defining a plurality of cylinder bores 28 containing movable pistons 14, one of which is shown. The cylinder block 12 electrically connects to an electrical ground 44. Operation of the engine 100 is controlled by an engine controller 60, which communicates with a plasma ignition controller 50 to control operation of a plurality of groundless dielectric barrier-discharge igniters (plasma igniters) 30 that are disposed in-cylinder to ignite fuel-air cylinder charges.

Each of the cylinder bores 28 houses a movable piston 14. The walls of the cylinder bore 28, a top portion of the piston 14 and an inner exposed portion of the cylinder head 18 define outer boundaries of a variable-volume combustion chamber 16 that is disposed therein. Each piston 14 mechanically couples to a connecting rod that rotatably couples to a crankshaft, and the piston 14 slidably translates within the cylinder bore 28 between a top-dead-center (TDC) position and a bottom-dead-center (BDC) position to transfer power to the crankshaft during combustion events.

The cylinder head 18 includes a pass-through aperture 19 that provides structure for mounting one of the plasma igniters 30 such that a tip 34 of the plasma igniter 30 protrudes into the combustion chamber 16 by a preferred distance, which is indicated by numeral 17. As used herein, the term “groundless” indicates absence of a discrete element or structure proximal to the tip 34 of the plasma igniter 30 fabricated from material that is capable of electrically coupling to an electrical ground path.

The cylinder head 18 includes an intake port or runner 24 that is in fluid communication with the combustion chamber 16, with an intake valve 20 disposed within for controlling airflow into the combustion chamber 16. The cylinder head 18 also includes an exhaust port or runner 26 that is in fluid communication with the combustion chamber 16, with an exhaust valve 22 disposed within for controlling exhaust gas flow 46 out of the combustion chamber 16. FIG. 1 shows a single intake valve 20 and a single exhaust valve 22 associated with the combustion chamber 16, but it is appreciated that each combustion chamber 16 may be configured with multiple intake valves and/or multiple exhaust valves. Openings and closings of the intake and exhaust valves 20, 22 are effected by urgings of valve springs and lobes on one or more rotating camshafts that are rotatably coupled to the crankshaft, or other suitable mechanisms. In this embodiment, the fuel injector 40 is disposed to inject fuel into the intake runner 24 upstream of the intake valve 20. The fuel injector 40 fluidly and operatively couples to a fuel injection system, which supplies pressurized fuel at a flowrate that is suitable to operate the engine.

One embodiment of the plasma igniter 30 is described with reference to FIGS. 3 and 4, and preferably includes a single power electrode 33 encased in a casing 32 formed from dielectric material, wherein the electrode 33 has a tip portion 34 near a second, distal end 36 that is opposite a first end 35 that electrically connects to the plasma ignition controller 50. In certain embodiments, the tip portion 34 of the electrode 33 is embedded in the casing 32 and has a thickness that is within a range between 1 mm and 5 mm. The plasma igniter 30 fixedly attaches to a mounting boss 31. The mounting boss 31 preferably threadably inserts through and attaches to the pass-through aperture 19 in the cylinder head 18 such that the tip portion 34 of the electrode 33 protrudes into the combustion chamber 16. The electrode 33 electrically connects to the plasma ignition controller 50 at its first end 35. The plasma ignition controller 50 monitors and controls operation of the plasma igniter 30, employing electric power supplied from a power source 55, e.g., a battery. The plasma ignition controller 50 electrically connects to the electrical ground path 44, thus forming an electrical ground connection to the cylinder head 18. The plasma ignition controller 50 is configured to apply a high-frequency, high-voltage electrical pulse to the plasma igniter 30 to generate a plasma discharge event.

The casing 32 provides a dielectric barrier around the electrode 33, preferably such that the length of the electrode 33 extends into the combustion chamber 16 when the plasma igniter 30 is in an installed position in the cylinder head 18. As such, the electrode 33 is fully encapsulated by the dielectric material. The casing 32 may be configured in a frustoconical shape that tapers in a narrowing fashion towards the second end 36. This example is non-limiting, and the dielectric casing 32 may be otherwise shaped and/or contoured relative to the contour of the second end 36. The second end 36 may be shaped, for example, as a conical end, a cylindrical end, a chamfered cylindrical end, etc. Other cross-sectional shapes, e.g., oval, rectangular, hexagonal, etc., may be employed. Other configurations of groundless dielectric barrier-discharge plasma igniters may be employed with similar effect. Other non-limiting embodiments of groundless dielectric barrier-discharge plasma igniters may be found in International Application Publication Number WO 2015/130655 A1 with an International Publication Date of Sep. 3, 2015, which is also assigned to the Applicant. The dielectric material may be any suitable dielectric material capable of withstanding the temperatures and pressures of an engine combustion chamber. For example, the dielectric material may be a glass, quartz, or ceramic dielectric material, such as a high purity alumina

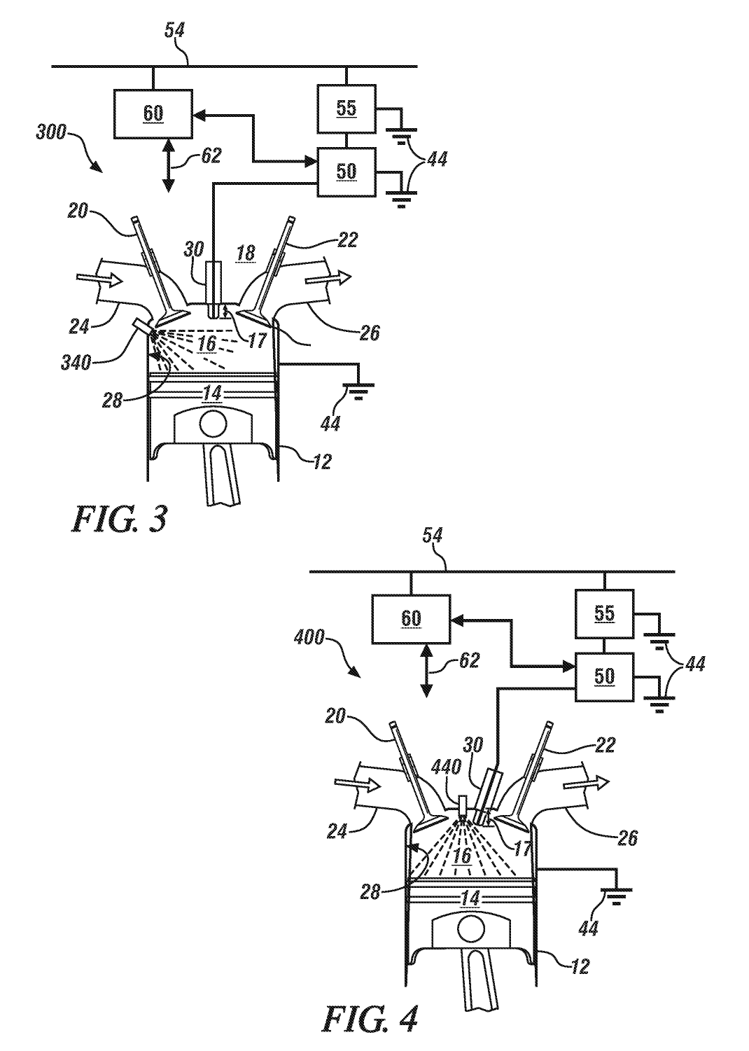

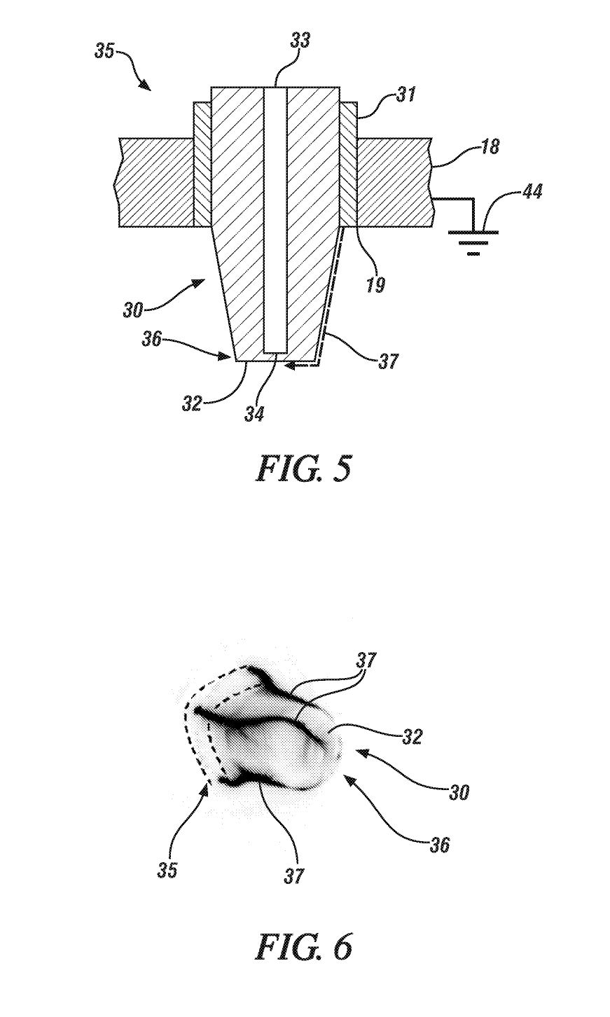

During each plasma discharge event, the plasma ignition controller 50 applies a high-frequency, high-voltage electrical pulse to the electrode 33. In one example, the high-frequency, high-voltage electrical pulse may have a peak primary voltage of 100 V, secondary voltages between 10 and 70 kV, a duration of 2.5 ms, and a total energy of 1.0 J, with the frequency of the voltage in the range of one megahertz (MHz). The plasma discharge event generates one or a plurality of plasma discharge streamers 37, as best shown with reference to FIG. 5 or 6, which originate at the mounting boss 31 and propagate towards the tip portion 34. The plasma discharge streamers 37 may propagate across a surface of a longitudinal portion of the dielectric casing 32 of the electrode 33 in multiple radial locations and terminate on the second end 36 at or near the tip portion 34. The plasma discharge streamers 37 interact with and ignite the cylinder charge, which combusts in the combustion chamber 16 to generate mechanical power. The specific details of the configuration of the plasma igniter 30, its arrangement in the combustion chamber 16, and operating parameters (peak voltage, frequency and duration) associated with electric power and timing of activation during each plasma discharge event are application-specific, and are preferably selected to achieve desired combustion characteristics within the combustion chamber 16. The multiple plasma discharge streamers 37 generate a large discharge area for effective flame development in stoichiometric homogeneous, lean homogeneous, rich homogeneous, and/or lean/rich stratified and lean controlled auto-ignition combustion applications.

The plasma ignition controller 50 monitors and controls operation of the plasma igniter 30, employing electric power from a power source 55, e.g., a battery. The plasma ignition controller 50 electrically connects to the electrical ground path 44, thus forming an electrical ground connection to the cylinder head 18. The plasma ignition controller 50 is configured to apply the high-frequency, high-voltage electrical pulse to the barrier discharge plasma igniter 30 in response to a control signal communicated from the engine controller 60. In one example, the high-frequency, high-voltage electrical pulse may have a peak primary voltage of 100 V, secondary voltages between 10 and 70 kV, a duration of 2.5 ms, and a total energy of 1.0 J, with the frequency of the voltage near one megahertz (MHz). The high-frequency, high-voltage electrical pulse concentrates an electric field at the tip portion 34, which ionizes a proximal combustible air-fuel mixture to form a plasma discharge that ignites a fuel-air cylinder charge. The plasma discharge may be in the form of one or a plurality of plasma discharge streamers 37, as best shown with reference to FIG. 6. The plasma discharge streamers 37 interact with and ignite the cylinder charge, which combusts in the combustion chamber 26 to generate mechanical power. The specific details of the configuration of the igniter 30, its arrangement in the combustion chamber 16, and operating parameters (peak voltage, frequency and duration) associated with electric power and timing of activation are application-specific, and are preferably selected to achieve desired combustion characteristics within the combustion chamber 16. The multiple plasma discharge streamers 37 produced at the tip portion 34 generate a large discharge area for effective flame development in stoichiometric homogeneous, lean homogeneous, rich homogeneous, and/or lean/rich stratified and lean controlled auto-ignition combustion applications.

The engine controller 60 is configured to monitor parameters associated with operation of the engine 100 and send command signals to control actuators of the engine 100, as indicated by line 62. The engine 100 selectively operates in one of a plurality of combustion modes depending upon operating conditions, including a homogeneous-charge compression-ignition (HCCI) combustion mode or a stratified charge combustion mode, both of which include operating at an air/fuel ratio that is primarily lean of stoichiometry, and a spark-ignition (SI) combustion mode, which includes operating at a stoichiometric air/fuel ratio. The disclosure may be applied to various engine systems and combustion cycles. In one embodiment, the engine 100 may be operably connected to a plurality of wheels disposed on one or more axles of a vehicle (not shown) to provide tractive power. For example, the engine 100 may be connected to a transmission (not shown) which may in turn rotate the one or more axles. The engine 100 may provide direct tractive power to the plurality of wheels, such as via the transmission connected to the one or more axles, or may provide power to one or more electric motors (not shown) that may in turn provide direct motive power to the plurality of wheels. In any event, the engine 100 may be configured to provide power to a vehicle by combusting fuel and converting chemical energy to mechanical energy.

The fuel injector 40 includes a flow control valve and a fuel nozzle that is disposed to inject fuel into the combustion chamber 16. The fuel may be any suitable composition such as, but not limited to, gasoline, ethanol, diesel, natural gas, and combinations thereof The fuel nozzle may extend through the cylinder head 18 into the combustion chamber 16. Furthermore, the cylinder head 18 may be arranged with the fuel injector 40 and fuel nozzle disposed in a geometrically central portion of a cylindrical cross-section of the combustion chamber 16 and aligned with a longitudinal axis thereof The fuel nozzle may be arranged in line with the plasma igniter 30 between the intake valve 20 and the exhaust valve 22. Alternatively, the cylinder head 18 may be arranged with the fuel nozzle disposed in line with the plasma igniter 30 and orthogonal to a line between the intake valve 20 and the exhaust valve 22. Alternatively, the cylinder head 18 may be arranged with the fuel nozzle disposed in a side injection configuration. The arrangements of the cylinder head 18 including the fuel nozzle and the plasma igniter 30 described herein are illustrative. Other suitable arrangements may be employed within the scope of this disclosure.

The fuel nozzle includes an end defining one or a plurality of opening(s) (not shown) through which fuel flows into the combustion chamber 16, forming a spray pattern that includes a single one or a plurality of fuel plumes. The shape and penetration of the fuel plume(s) is a result of fuel momentum caused by fuel pressure and the configuration of the fuel nozzle, including cross-sectional area, shape and orientation of the opening(s) of the fuel nozzle relative to the combustion chamber 16, and combustion chamber flow dynamics. The combustion chamber flow dynamics may be driven by the shape of the combustion chamber 16, including presence of devices for generating swirl therein in certain embodiments, and other factors.

By way of non-limiting examples, when the fuel nozzle includes a single-aperture device including a pintle and seat with a single circular cross-sectional opening into the combustion chamber 16, the resulting fuel spray pattern may be a single plume having a continuous, generally hollow conical shape. Alternatively, the fuel nozzle may be a multi-aperture device including a pintle and seat with a plurality of openings through which fuel passes, and the resulting fuel spray pattern includes a plurality of radially projecting fuel plumes. In an embodiment wherein the fuel nozzle includes a plurality of openings, the fuel spray pattern formed during fuel injection includes a plurality of radially projecting fuel plumes that together form a generally conical shape in the combustion chamber 16 when viewed from a side view of the combustion chamber 16, wherein the conical shape has a spray angle that is preferably measured between major axes of one of the spray plumes that are oriented 180° apart on the fuel nozzle, or as outer boundaries defining the spray angle. Each of the plurality of spray plumes may have a generally conical shape, a generally flat shape or another suitable shape that is primarily dependent upon the cross-sectional shape of the openings of the fuel nozzle.

Embodiments of the plasma ignition system including the groundless barrier-discharge plasma igniter configured as described herein may facilitate stable low-temperature combustion at highly dilute operating conditions when combined with a multiple fuel injection strategy, and thus provide an alternative to a spark plug ignition system that can enhance low-temperature, dilute combustion at high combustion pressures while achieving robust lean low-temperature combustion.

FIG. 2 schematically illustrates a cross-sectional view of a single cylinder for a multi-cylinder internal combustion engine (engine) 200, including an engine block 12 defining a plurality of cylinder bores 28 containing movable pistons 14, one of which is shown. The engine 200 further includes an embodiment of the plasma igniter 30 that is centrally located relative to a longitudinal axis of the cylinder bore 28, including tip 34 of the plasma igniter 30 that protrudes into the combustion chamber 16. In this embodiment, the fuel injector 40 is disposed to inject fuel into the intake runner 24. Furthermore, a second fuel injector 240 may be disposed on a side of the cylinder head 18 to inject fuel into a side of the combustion chamber 16. In all other aspects, the engine 200 and plasma igniter 30 are analogous to the engine 100 and plasma igniter 30 described with reference to FIGS. 1, 5 and 6. This fuel injection arrangement facilitates various combustion modes including wall-guided stratified-charge spark ignition modes.

FIG. 3 schematically illustrates a cross-sectional view of a single cylinder for a multi-cylinder internal combustion engine (engine) 300, including an engine block 12 defining a plurality of cylinder bores 28 containing movable pistons 14, one of which is shown. The engine 300 further includes an embodiment of the plasma igniter 30 that is centrally located relative to a longitudinal axis of the cylinder bore 28, including tip 34 of the plasma igniter 30 that protrudes into the combustion chamber 16. In this embodiment, fuel injector 340 is disposed to inject fuel into a side of the combustion chamber 16. In all other aspects, the engine 300 and plasma igniter 30 are analogous to the engine 1000 and plasma igniter 30 described with reference to FIGS. 1, 5 and 6. This fuel injection arrangement facilitates various combustion modes including wall- or spray-guided stratified-charge spark ignition modes.

FIG. 4 schematically illustrates a cross-sectional view of a single cylinder for a multi-cylinder internal combustion engine (engine) 400, including an engine block 12 defining a plurality of cylinder bores 28 containing movable pistons 14, one of which is shown. The engine 400 further includes an embodiment of the plasma igniter 30 that is located at an angle relative to a longitudinal axis of the cylinder bore 28, including tip 34 of the plasma igniter 30 that protrudes into the combustion chamber 16. In this embodiment, fuel injector 440 is centrally disposed to inject fuel into the top of the combustion chamber 16, with the fuel injector 440 aligned with a longitudinal axis of the cylinder bore 28. In all other aspects, the engine 400 and plasma igniter 30 are analogous to the engine 100 and plasma igniter 30 described with reference to FIGS. 1, 5 and 6. This fuel injection arrangement facilitates engine operation in various combustion modes. In certain embodiments, a second fuel injector (not shown) is disposed to inject fuel into the intake runner 24 upstream of the intake valve 20.

As such, the engine configurations operative in stoichiometric and lean-operation combustion modes, including combustion formats that include propagating flame ignition, compression ignition and flame assisted compression ignition.

In each of the embodiments described with reference to FIGS. 1-4, the engine controller 60 monitors inputs from engine and vehicle sensors to determine states of engine parameters. The engine controller 60 is configured to receive operator commands, e.g., via an accelerator pedal and a brake pedal to determine an output torque request, from which engine control parameters and an engine torque command are derived. The engine controller 60 executes control routines stored therein to determine states for the engine control parameters to control the aforementioned actuators to form a cylinder charge, including controlling throttle position, compressor boost, plasma ignition timing, fuel injection pulsewidth affecting injected fuel mass and timing, EGR valve position to control flow of recirculated exhaust gases, and intake and/or exhaust valve timing and phasing. Valve timing and phasing may include negative valve overlap (NVO) and lift of exhaust valve reopening (in an exhaust re-breathing strategy), and positive valve overlap (PVO). Engine parameters associated with a cylinder charge that are affected by individual engine control parameters may include air/fuel ratio, intake oxygen, engine mass airflow (MAF), manifold pressure (MAP) and mass-burn-fraction point (CA50 point). The air/fuel ratio may be controlled by the fuel injection pulsewidth and affects an amount of fuel injected into each combustion chamber 16 during each engine cycle. The engine mass airflow (MAF) and manifold pressure (MAP) are controlled by controlling NVO/PVO, electronic throttle control, and a turbocharger (when employed) and affects a magnitude of trapped air mass and a magnitude of residual gases in the combustion chamber 16. The intake oxygen may be controlled by the EGR valve, which controls a magnitude of external EGR during each engine cycle. The engine parameters of MAF, actual air/fuel ratio, intake oxygen, MAP and CA50 point may be directly measured using sensors, inferred from other sensed parameters, estimated, derived from engine models or otherwise dynamically determined by the engine controller 60.

The terms controller, control module, module, control, control unit, processor and similar terms refer to any one or various combinations of Application Specific Integrated Circuit(s) (ASIC), electronic circuit(s), central processing unit(s), e.g., microprocessor(s) and associated non-transitory memory component in the form of memory and storage devices (read only, programmable read only, random access, hard drive, etc.). The non-transitory memory component is capable of storing machine readable instructions in the form of one or more software or firmware programs or routines, combinational logic circuit(s), input/output circuit(s) and devices, signal conditioning and buffer circuitry and other components that can be accessed by one or more processors to provide a described functionality. Input/output circuit(s) and devices include analog/digital converters and related devices that monitor inputs from sensors, with such inputs monitored at a preset sampling frequency or in response to a triggering event. Software, firmware, programs, instructions, control routines, code, algorithms and similar terms mean any controller-executable instruction sets including calibrations and look-up tables. Each controller executes control routine(s) to provide desired functions, including monitoring inputs from sensing devices and other networked controllers and executing control and diagnostic instructions to control operation of actuators. Routines may be periodically executed at regular intervals, for example each 100 microseconds during ongoing operation. Alternatively, routines may be executed in response to occurrence of a triggering event. Communication between controllers, and communication between controllers, actuators and/or sensors may be accomplished using a direct wired link, a networked communication bus link, a wireless link or another suitable communications link. Communication includes exchanging data signals in any suitable form, including, for example, electrical signals via a conductive medium, electromagnetic signals via air, optical signals via optical waveguides, and the like. Data signals may include signals representing inputs from sensors, signals representing actuator commands, and communications signals between controllers. The term ‘model’ refers to a processor-based or processor-executable code and associated calibration that simulates a physical existence of a device or a physical process.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims.

1. An internal combustion engine, comprising:
a combustion chamber defined by a cylinder bore formed in a cylinder block, a cylinder head and a piston;
a groundless barrier discharge plasma igniter including an electrode embedded in a casing fabricated from a dielectric material and disposed in a mounting boss, the groundless barrier discharge plasma igniter having a tip portion that protrudes through an opening in the cylinder head into the combustion chamber; and
a controller having an electrical ground connection to the cylinder head and configured to apply a high-frequency, high-voltage electrical pulse to the groundless barrier discharge plasma igniter;
wherein an electrical ground path is formed between the mounting boss and the cylinder head; and
wherein a plasma discharge streamer is generated on the casing between the tip portion and the mounting boss when the controller applies the high-frequency, high-voltage electrical pulse to the groundless barrier discharge plasma igniter.

2. The internal combustion engine of claim 1, further comprising the plasma discharge streamer generated on the casing between the tip portion and the mounting boss when the controller applies the high-frequency, high-voltage electrical pulse to the groundless barrier discharge plasma igniter in the presence of a cylinder fuel-air charge.

3. The internal combustion engine of claim 2, further comprising a fuel injector disposed to inject fuel into the combustion chamber, and wherein the cylinder charge is formed by the injected fuel.

4. The internal combustion engine of claim 3, wherein the fuel injector disposed to inject fuel into the combustion chamber comprises the fuel injector disposed to inject fuel into an intake port upstream of an intake valve.

5. The internal combustion engine of claim 3, wherein the fuel injector disposed to inject fuel into the combustion chamber comprises the fuel injector disposed to directly inject fuel into the combustion chamber.

6. The internal combustion engine of claim 5, wherein the fuel injector is disposed to inject fuel into a side portion of the combustion chamber.

7. The internal combustion engine of claim 5, wherein the fuel injector is disposed to inject fuel into a top center portion of the combustion chamber.

8. The internal combustion engine of claim 3, wherein the fuel injector disposed to inject fuel into the combustion chamber comprises a first fuel injector disposed to inject fuel into an intake port upstream of an intake valve and a second fuel injector disposed to directly inject fuel into a side portion of the combustion chamber.

9. The internal combustion engine of claim 3, wherein the fuel injector disposed to inject fuel into the combustion chamber comprises a first fuel injector disposed to inject fuel into an intake port upstream of an intake valve and a second fuel injector disposed to directly inject fuel into a top center portion of the combustion chamber.

10. The internal combustion engine of claim 1, wherein the controller configured to apply a high-frequency, high-voltage electrical pulse to the groundless barrier discharge plasma igniter comprises the controller configured to apply an electrical pulse having a frequency near 1 megahertz at a voltage in the range of 10 to 70 kilovolts.

11. An internal combustion engine, comprising:
a combustion chamber defined by a cylinder bore formed in a cylinder block, a cylinder head and a piston;
a fuel injector disposed to inject fuel into the combustion chamber to form a cylinder charge;
a groundless barrier discharge plasma igniter including an electrode embedded in a casing fabricated from a dielectric material and disposed in a mounting boss, the groundless barrier discharge plasma igniter having a tip portion that protrudes through an opening in the cylinder head into the combustion chamber;
a controller having an electrical ground connection to the cylinder head; and
the controller configured to apply a high-frequency, high-voltage electrical pulse to the groundless barrier discharge plasma igniter;
wherein a plurality of plasma discharge streamers is generated on the casing between the tip portion and the cylinder head when the controller applies the high-frequency, high-voltage electrical pulse to the groundless barrier discharge plasma igniter.

12. The internal combustion engine of claim 11, further comprising the plasma discharge streamers generated on the casing between the tip portion and the cylinder head when the controller applies the high-frequency, high-voltage electrical pulse to the groundless barrier discharge plasma igniter in the presence of the cylinder charge.

13. The internal combustion engine of claim 11, wherein the fuel injector disposed to inject fuel into the combustion chamber comprises the fuel injector disposed to inject fuel into an intake port upstream of an intake valve.

14. The internal combustion engine of claim 11, wherein the fuel injector disposed to inject fuel into the combustion chamber comprises the fuel injector disposed to directly inject fuel into the combustion chamber.

15. The internal combustion engine of claim 14, wherein the fuel injector is disposed to inject fuel into a side portion of the combustion chamber.

16. The internal combustion engine of claim 14, wherein the fuel injector is disposed to inject fuel into a top center portion of the combustion chamber.

17. The internal combustion engine of claim 11, wherein the controller is configured to apply a high-frequency, high-voltage electrical pulse to the groundless barrier discharge plasma igniter comprises the controller configured to apply an electrical pulse having a frequency near 1 megahertz at a voltage in the range of 10-70 kilovolts.

18. The internal combustion engine of claim 11, wherein the fuel injector disposed to inject fuel into the combustion chamber comprises a first fuel injector disposed to inject fuel into an intake port upstream of an intake valve and a second fuel injector disposed to directly inject fuel into a side portion of the combustion chamber.

19. The internal combustion engine of claim 11, wherein the fuel injector disposed to inject fuel into the combustion chamber comprises a first fuel injector disposed to inject fuel into an intake port upstream of an intake valve and a second fuel injector disposed to directly inject fuel into a top center portion of the combustion chamber.
